(19) United States
(12) Patent Application Publication
(10) Pub. No.: US 2026/0200430 A1
(43) Pub. Date: Jul. 16, 2026

(54) SEATBELT RETRACTOR WITH ADJUSTABLE CONTEXT-BASED DAMPER FOR A VEHICLE

(71) Applicant: GM GLOBAL TECHNOLOGY OPERATIONS LLC, Detroit, MI (US)

(72) Inventors: Paul W. Alexander, Ypsilanti, MI (US); Sean Taylor Coughlin, Shelby Township, MI (US); Senthil Karuppaswamy, Rochester hills, MI (US)

(73) Assignee: GM GLOBAL TECHNOLOGY OPERATIONS LLC, Detroit, MI (US)

(21) Appl. No.: 19/018,083

(22) Filed: Jan. 13, 2025

(51) Int. Cl. B60R 22/343; B60R 22/34

(52) U.S. Cl. CPC B60R 22/343; B60R 22/3413

(57) ABSTRACT

A seatbelt retractor includes a housing holding fixed opposing first and second races, and a spool defining an axis of rotation and rotatably mounted on and between the first and second races. The spool is attached to a seatbelt having a web arranged to be wound around the spool and unwound from the spool. A damper is connected to the spool and extending axially relative to the axis. A body with a chamber holds a rheological fluid. The damper is arranged to axially and movably extend into the rheological fluid to effect motion of the web. An activation mechanism applies energy to the rheological fluid to change a viscosity of the rheological fluid.

### INTRODUCTION

The technical field generally relates to vehicles and, more specifically, to vehicles with seatbelt retractors that control the extension and tension in the seatbelt.

Many vehicles have seatbelts to limit the movement of an occupant in a vehicle when the vehicle experiences abrupt changes in motion, such as with fast deceleration events or events with contact with another object, to limit contact between the occupant and other objects on or near the vehicle. The seatbelts also have mechanisms to control seatbelt webbing (or web) payout or slack so that the seatbelt itself does not apply too much load or force onto the occupant during these events. Accordingly, it is desirable to provide an adaptable seatbelt retractor that is adjustable to provide different amounts of the webbing payout or slack depending on varying characteristics of the context at the vehicle. Furthermore, other desirable features and characteristics of the present disclosure will become apparent from the subsequent detailed description and the appended claims, taken in conjunction with the accompanying drawings and the foregoing introduction.

### SUMMARY

In an example implementation, a seatbelt retractor includes a housing holding fixed opposing first and second races, and a spool defining an axis of rotation and rotatably mounted on and between the first and second races. The spool is attached to a seatbelt having a web arranged to be wound around the spool and unwound from the spool. A damper is connected to the spool and extending axially relative to the axis. A body with a chamber holds a rheological fluid. The damper is arranged to axially and movably extend into the rheological fluid to effect motion of the web. An activation mechanism applies energy to the rheological fluid to change a viscosity of the rheological fluid.

Also in an example implementation, the rheological fluid is a magnetorheological (MR) fluid. The energy is created by the application of a magnetic field that causes the rheological fluid to slow or stop rotation of the spool.

Also in an example implementation, the rheological fluid is an electrorheological (ER) fluid. The energy is created by the application of an electric field that causes the rheological fluid to slow or stop rotation of the spool.

Also in an example implementation, the damper is rotationally fixed to the spool. The damper is rotatable within the rheological fluid.

Also in an example implementation, the seatbelt retractor includes a torsion bar and a locking race with a locked state and a rotating state rotatable about the axis. The torsion bar has a first end fixed to the locking race and a second end rotatably fixed to the spool. The torsion bar is arranged to twist when the locking race is in the locked state and the spool is rotating. A viscosity of the rheological fluid is arranged to be increased in the locked state as a twist of the torsion bar increases.

Also in an example implementation, the seatbelt retractor includes a spindle rotatable about the axis, rotationally fixed to the locking race, axially translatable relative to the locking race, and having a connection to the spool so that rotating the spool in the locked state moves the spindle axially and closer to the chamber. The spindle has at least one magnet that moves closer to the chamber as the spindle moves closer to the chamber.

Also in an example implementation, the spool has a rotatable interior surface. The spindle is threaded to the interior surface.

Also in an example implementation, the spool includes a distal end facing the chamber. The damper includes at least one stem portion extending from the distal end and into the chamber and a restraining portion coupled to the at least one stem portion and being disposed within the rheological fluid.

Also in an example implementation, the damper is rotatable about the axis and has a rotationally locked state and a rotationally unlocked state. The damper has a spindle portion within the spool and a restraining portion coupled to the spindle portion and being disposed within the rheological fluid. The spindle portion has a connection to the spool so that the damper moves axially when the spool rotates in the rotationally locked state to move the restraining portion axially within the rheological fluid.

Also in an example implementation, the seatbelt retractor includes a damping control communicatively coupled to a field generator and being arranged to selectively control a strength of a magnetic field or an electric field to be applied to the rheological fluid depending on data indicating a current context at the vehicle.

Also in an example implementation, the current context includes at least one of: characteristics of an occupant wearing the seatbelt, an indicator of motion of the web, a force being exerted against the web, a condition or parameter of the vehicle, and navigational-related data indicating objects being detected that are other than part of the vehicle.

In an example implementation, a seatbelt system includes a seatbelt having a web extending over at least one seat of a vehicle and having a web end, and a seatbelt retractor connected to the web end. The seatbelt retractor includes a housing holding fixed opposing first and second races, and a spool defining an axis of rotation and rotatably mounted on and between the first and second races. The spool is attached to a seatbelt having a web arranged to be wound around the spool and unwound from the spool. A damper is connected to the spool and extending axially relative to the axis, and a body has a chamber holding a rheological fluid. The damper is arranged to axially and movably extend into the rheological fluid to effect motion of the web, and an activation mechanism applies energy to the rheological fluid to change a viscosity of the rheological fluid while the web is being extended from the seatbelt retractor.

Also in an example implementation, the seatbelt system includes a at least one magnet on the damper or in a vicinity of the chamber on the body. The damper is arranged so that a distance between the at least one magnet and the damper becomes smaller as a velocity or acceleration of the web increases.

Also in an example implementation, the seatbelt system includes at least one movable magnet disposed in a proximity to the chamber and on the body and generating a magnetic field. At least one magnet actuator is on the body and coupled to the at least one movable magnet to move the at least one magnet to a position with a distance from the chamber to apply a predetermined strength of the magnetic field to the rheological fluid.

Also in an example implementation, the seatbelt system includes a damping control arranged to receive context data to determine a predetermined field strength before a use of the vehicle. A field generator at the body is communicatively coupled to the damping control to generate a magnetic or electric field at the predetermined field strength to apply to the rheological fluid during the use of the vehicle.

In an example implementation, a vehicle includes at least one seat; a seatbelt at each seat front, and a seatbelt retractor at each seatbelt, The seatbelt retractor includes opposing first and second races, and a spool defining an axis of rotation and rotatably mounted on and between the first and second races. The spool is attached to a seatbelt web arranged to wind the seatbelt web around the spool. A damping portion is connected to the spool and extending axially relative to the axis. A body has a chamber holding a rheological fluid. The damping portion extends into the rheological fluid. An activation mechanism that applies energy to the rheological fluid to change a viscosity of the rheological fluid.

Also in an example implementation, the damping portion is rotatable about the axis and has a rotationally locked state and a rotationally unlocked state. The damping portion has a spindle portion within the spool and a restraining portion coupled to the spindle portion and being disposed within the rheological fluid. The spindle portion has a connection to the spool so that the damping portion moves axially when the spool rotates in the rotationally locked state to move the restraining portion axially within the rheological fluid. The body includes multiple magnets disposed along an axial direction relative to the axis and having different sizes or different materials with different magnetic strengths so that the viscosity of the rheological fluid near the restraining portion is greater the more the spool rotates in the rotationally locked state and the farther the restraining portion axially moves within the rheological fluid from a start position.

Also in an example implementation, the restraining portion includes at least one stem portion coupled to the spindle portion and a plate-shaped end coupled to the at least one stem portion. The plate-shaped end comprises an outer peripheral rim having at least one magnet.

Also in an example implementation, the first race includes the body and holds the chamber. The first race includes a field generator proximal to the chamber and being arranged to form a magnetic or electric field to apply to the rheological fluid in the chamber.

Also in an example implementation, the activation mechanism is arranged to change the viscosity of the rheological fluid while the web is retracting into the seatbelt retractor.

### DESCRIPTION OF THE DRAWINGS

The present disclosure will hereinafter be described in conjunction with the following drawing figures, wherein like numerals denote like elements and the drawings are not to scale, and wherein:

FIG. 1 is a schematic diagram of a front view of an example seatbelt system at a seat of a vehicle according to at least one of the implementations herein;

FIG. 2 is a schematic diagram of a perspective rear and side view of an example seatbelt retractor according to at least one of the implementations herein;

FIG. 3 is a schematic diagram of a side view of an example seatbelt retractor according to at least one of the implementations herein;

FIG. 4 is a schematic diagram of a cross-sectional side view of an example seatbelt retractor shown in a first stage of operation according to at least one of the implementations herein;

FIG. 4A is a schematic diagram of a perspective view of a spindle to locking race coupling for a seatbelt retractor according to at least one of the implementations herein;

FIG. 4B is a schematic diagram of a side cross-sectional view of the coupling of FIG. 4A according to at least one of the implementations herein;

FIG. 5 is a schematic diagram of a cross-sectional side view of the example seatbelt retractor of FIG. 4 in a second stage of operation according to at least one of the implementations herein;

FIG. 6 is a schematic diagram of a cross-sectional side view of the example seatbelt retractor of FIG. 4 in a third stage of operation according to at least one of the implementations herein;

FIG. 7 is a schematic diagram of a cross-sectional side view of the example seatbelt retractor of FIG. 4 in a fourth stage of operation according to at least one of the implementations herein;

FIG. 8 is a schematic diagram of a side view of an example seatbelt retractor showing a locking mechanism to lock a locking race according to at least one of the implementations herein;

FIG. 9 is a schematic diagram of a cross-sectional side view of an alternative example seatbelt retractor according to at least one of the implementations herein;

FIG. 10 is a schematic diagram of a seatbelt retractor control system for controlling the seatbelt retractor of FIG. 9 according to at least one of the implementations herein;

FIG. 11 is a schematic diagram of a cross-sectional side view of another alternative example seatbelt retractor according to at least one of the implementations herein;

FIG. 12 is a schematic diagram of a cross-sectional side view of yet another alternative example seatbelt retractor according to at least one of the implementations herein;

FIG. 13 is a schematic diagram of a cross-sectional side view of yet a further example seatbelt retractor in a first stage of operation according to at least one of the implementations herein;

FIG. 13A is a schematic diagram of a perspective view of a plunger to locking race coupling for a seatbelt retractor according to at least one of the implementations herein;

FIG. 13B is a schematic diagram of a side cross-sectional view of the coupling of FIG. 13A according to at least one of the implementations herein;

FIG. 14 is a schematic diagram of a cross-sectional side view of the example seatbelt retractor of FIG. 13 in a second stage of operation according to at least one of the implementations herein.

FIG. 15 is a schematic diagram of a cross-sectional side view of the example seatbelt retractor of FIG. 13 in a third stage of operation according to at least one of the implementations herein; and

FIG. 16 is a schematic diagram of a cross-sectional side view of the example seatbelt retractor of FIG. 13 in a fourth stage of operation according to at least one of the implementations herein.

### DETAILED DESCRIPTION

The following detailed description merely describes example implementations and are not intended to limit the disclosure or the application and uses thereof. Furthermore, no intention exists to be bound by any theory presented in the preceding background or the following detailed description.

Herein, the terms ‘coupled’ and ‘connected’ are used interchangeably to refer to the relationship between objects and include direct contact between objects as well as connection through intervening objects.

Also herein, the terms ‘vertical’, ‘horizontal’, ‘up’, ‘down’, ‘higher’, and ‘lower’ are relative to each other on the vehicle and/or seatbelt retractor and not necessarily relative to the ground unless context clearly indicates otherwise. Also, the term ‘substantially’ refers to within 5% of a specified amount.

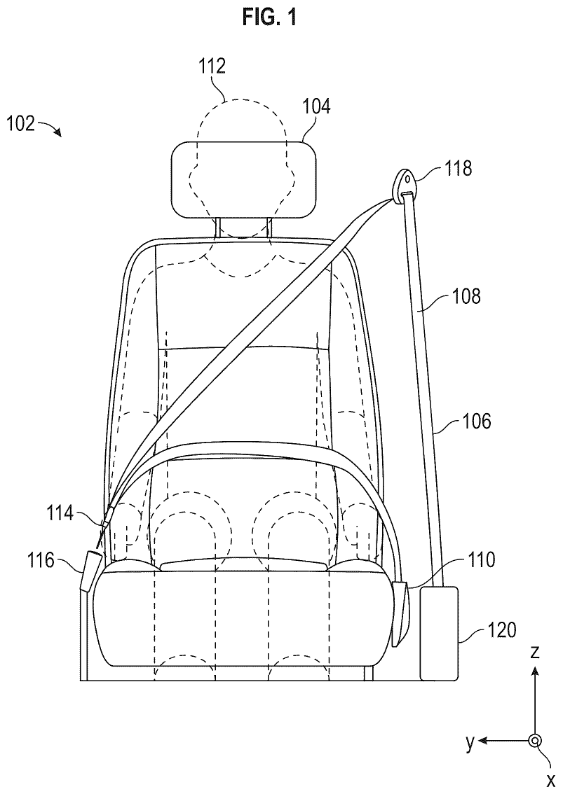

Referring to FIG. 1, an example vehicle 100 has an example seatbelt system 102 shown here extending over a vehicle seat 104 with a seatbelt 106 including a webbing (or web) 108 that extends from an end buckle 110 on one side of the seat 104. The end buckle 110 also is on one side of an occupant 112 sitting on the seat 104 and wearing the seatbelt 106. The web 108 extends over and across a lap of the occupant 112 to a latch plate 114 (or tongue piece) that buckles to a buckle 116. In this example, the web 108 extends through the latch plate 114 and diagonally upward and across a front of the occupant 112 and to a pillar loop piece 118. The web 108 extends through the pillar loop piece 118 and down to a seatbelt retractor 120 (or just retractor). A portion of the web 108 that extends downward from the pillar loop piece 118 and to the retractor 120, and the retractor itself, may be in an exposed position within the cabin of the vehicle 100 or alternatively may be hidden behind an interior cabin panel depending on the type of vehicle. The seatbelt system 102 may have many different configurations as long as a seatbelt retractor 120 is present that controls the winding and unwinding of the web 108. For orientation of the components and motion being discussed with the disclosed seatbelt system herein, axes are shown that remain consistent throughout the figures and where an x-axis extends between a front and rear of the vehicle or along a length of the vehicle, a y-axis extends laterally from side to side along a width of the vehicle, and a z-axis is a vertical axis.

The vehicle 100 may be an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain implementations such as trucks with more than four wheels, and so forth. In certain implementations, the vehicle 100 may also comprise any other motorized vehicle with a driver and/or passengers and seatbelts. The vehicle 100 also may be a vehicle that is not an automobile such as any other wheeled or land traveling vehicle, a water vehicle, a subterranean vehicle, an aircraft, a spacecraft, and so forth.

In operation, the occupant 112, whether a driver or passenger, sits in the seat 104 and pulls the latch plate 114 over their body to snap the latch plate 114 into the buckle 116 thereby extending the seatbelt over their lap and diagonally across their chest. During a sudden change in motion event of the vehicle 100, such as an extremely fast deceleration of the vehicle 100, the seatbelt retractor 120 will lock rotation and restrict extension. As the occupant moves forward and applies a forward force on the web due to the inertia of the vehicle, the seatbelt retractor 120 permits a slight amount of extension or payout (or slack) of the seatbelt to lessen or lower forces (or loads) from the web 108 and directed against the occupant 112. The presently disclosed seatbelt system 102 has a seatbelt retractor 120 described below that reduces the amount of web 108 being extended by a load limiter depending on the velocity (or acceleration) of the web 108 and/or other context of the event that is occurring to better provide a more effective, adjustable, customized amount of extension depending on the particular circumstances indicated by the context. This achieves a better balance between protection of the occupant 112 from objects near the occupant and reducing the force exerted on the occupant 112 by the web 108 itself. By alternative approaches, the disclosed seatbelt retractor can be used during retraction of the web 108 as well, if desired.

The seatbelt retractor 120 may be provided at each seatbelt system 102 in a vehicle, such as at each seat 104 in a vehicle or may be a different arrangement. The seatbelt system 102 also may have different configurations such as without a pillar loop (and without a high seat attachment) so that the web 108 only extends across an occupant's lap, or alternatively with a pillar loop only or high seat attachment only where the belt extends over the occupant's shoulder instead of across the lap. Many variations can be used as long as one of the versions of the disclosed seatbelt retractors is present.

To provide such effectiveness and balance, the presently disclosed vehicle 100 has a seatbelt retractor 120 with a load limiter, such as a torsion bar although other mechanisms may be used instead. The seatbelt retractor 120 also has a damper that limits the extension of the web by the load limiter. This is accomplished by having the damper connected to a spool of the retractor while also extending into a rheological fluid, such as a magnetorheological (MR) fluid or electrorheological (ER) fluid, that will increase in viscosity when an electrical or magnetic field is applied to the fluid. When a magnetic or electric field is applied to a magnetorheological (MR) or electrorheological (ER) fluid, the fluid undergoes a dramatic change in its rheological properties. Particles suspended in the fluid align along the field lines, forming chain-like structures that increase the fluid's viscosity and yield stress. This change effectively transforms the fluid from a free-flowing liquid to a semi-solid or viscoelastic material. The induced resistance to motion can slow or stop a member extending into the fluid by creating a controllable damping or braking energy (and in turn force), which is proportional to the strength of the applied field. Thus, exciting the MR or ER fluid, thickens (and/or stiffens) the fluid around the damper, which in turn slows or stops the spool, and in turn the web. Thus, the damper me be referred to as a rheological damper or MR/ER damper.

The field applied to the fluid can be controlled depending on the context at the vehicle in order to provide an adjustable, customized control of the field and amount of energy applied to the fluid, which in turn adjusts the amount of extension or payout of the web. Thus, the addition of an MR/ER damper may provide a velocity-based (or acceleration-based) mode for managing belt loads during an event. The damper structures herein also provide a number of different techniques to excite the MR/ER dampers before and/or during an event to further tune the seatbelt's energy management response to manage peak head and chest loads across a broader swath of occupant shapes and sizes. Thus. the damping performance can be tuned to an occupant's size and position, and/or other characteristics such as vehicle system inputs.

Since this arrangement provides a programable stiffness output, the output can be dynamically changed even during an event at the vehicle. For example, the retractor may provide a stiffness of the seatbelt that starts relatively high, and then subsequently provides a smaller load against an occupant for an event of relatively long duration or if the system senses a smaller occupant.

The different damping arrangements that can be used at the retractor can be categorized as passive or active, and each of these may be dynamic or tuned. Passive refers to an arrangement where no external power is used to excite the MR/ER fluid, while an active arrangement has a power source and a circuit with a field generator to generate a force or energy field, such as to generate a magnetic field or an electric field, to stiffen the MR/ER fluid. A dynamic arrangement refers to a seatbelt retractor that increases resistance to motion that varies as more force is experienced by the web, while a tuned arrangement has resistance to motion preset at a static value before loading.

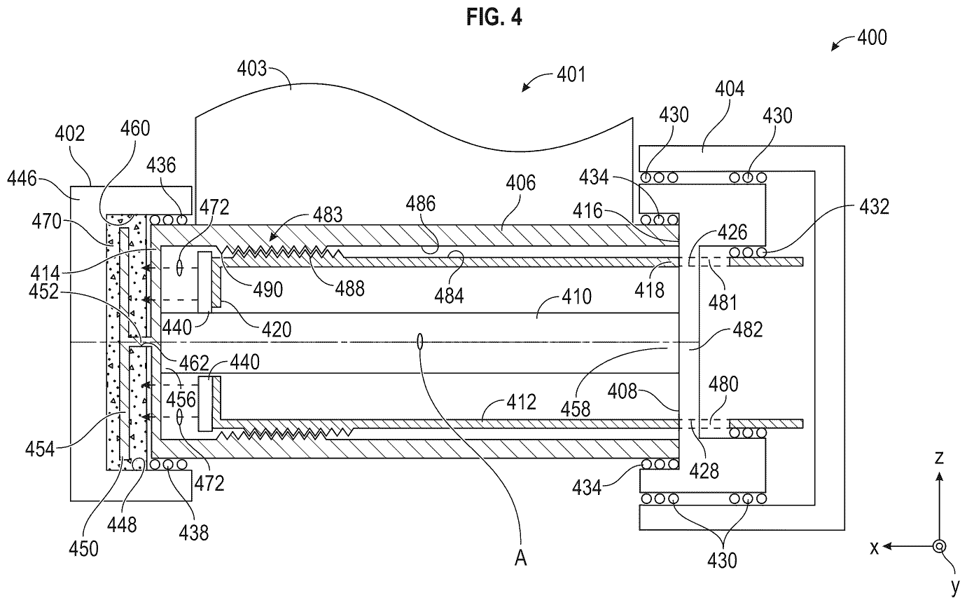

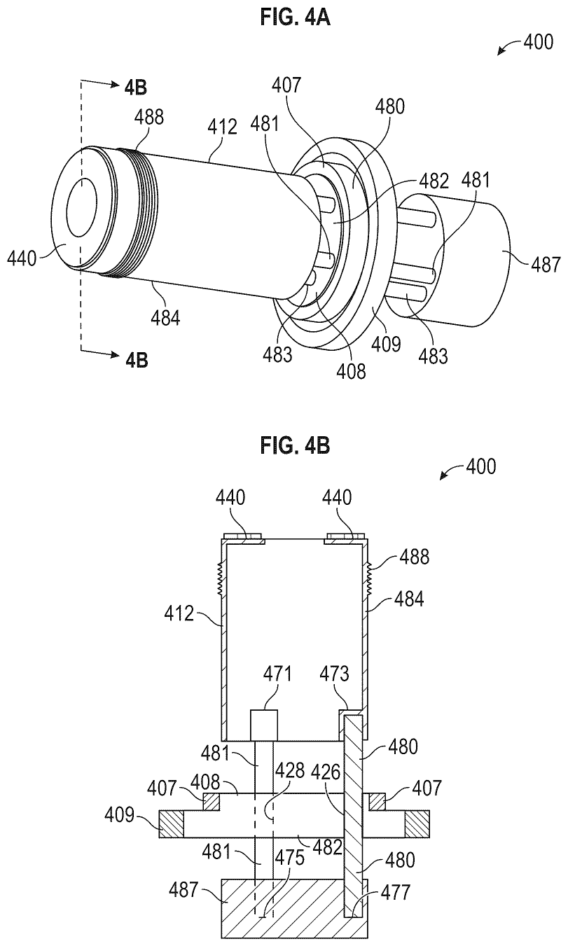

Thus, a passive and dynamic arrangement may have an ER or MR system with internal mechanical mechanisms that vary an activating field. This is disclosed by the arrangements of FIGS. 4-7 referred to as a clutch arrangement and 13-16 referred to as a plunger arrangement.

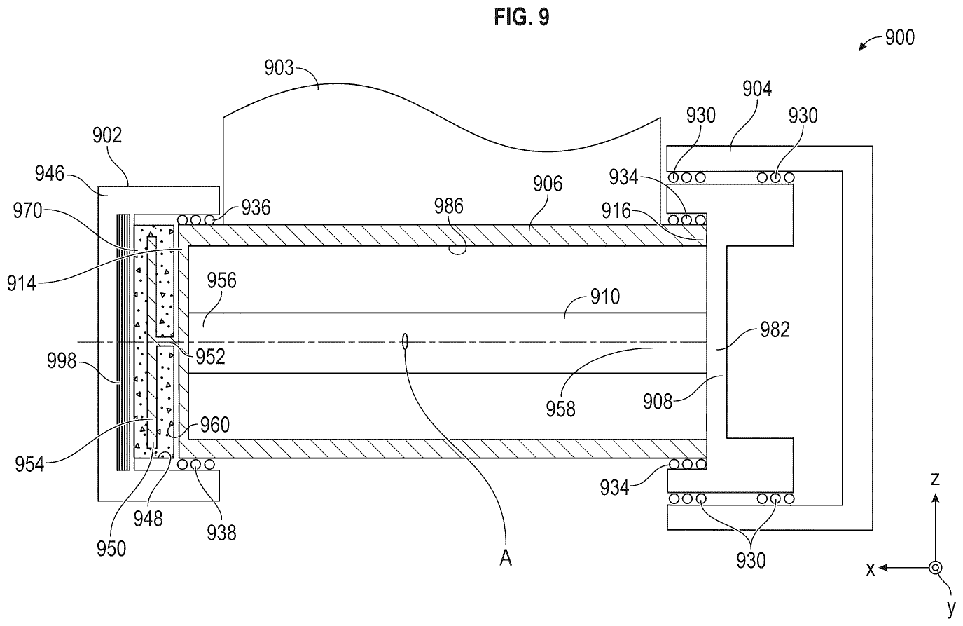

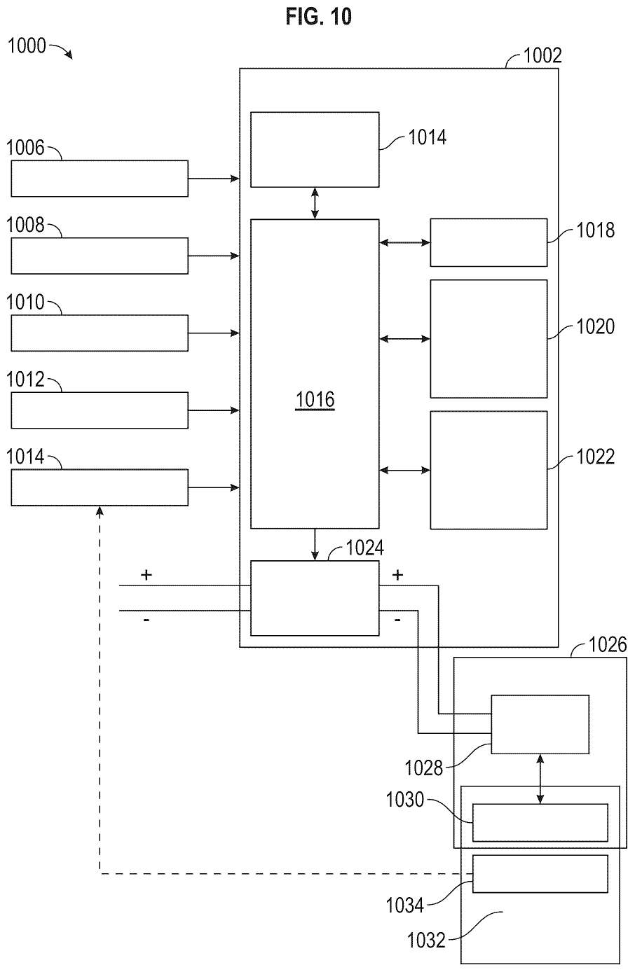

An active and tuned arrangement refers to an example MR or ER system where the activating field strength is set by a damping control (FIG. 10) at a selected power level (referred to as an open loop system) and this implementation is shown with FIG. 9.

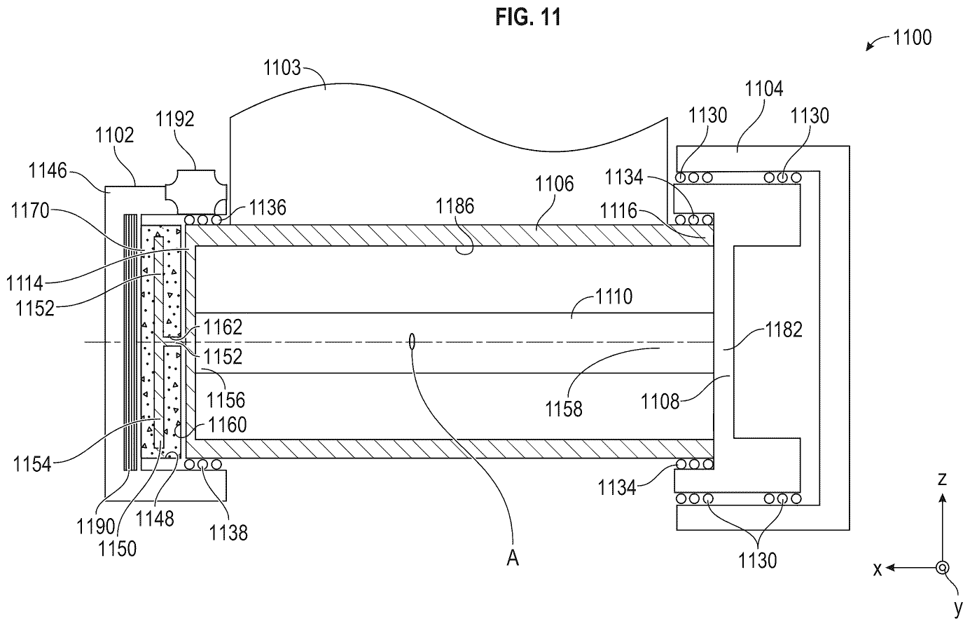

A passive and tuned arrangement refers to an ER or MR system with a selectable activating field strength set by changing physical parameters of the web sensed by a spool sensor as one example, and is shown on FIG. 11 and used with the control of FIG. 10.

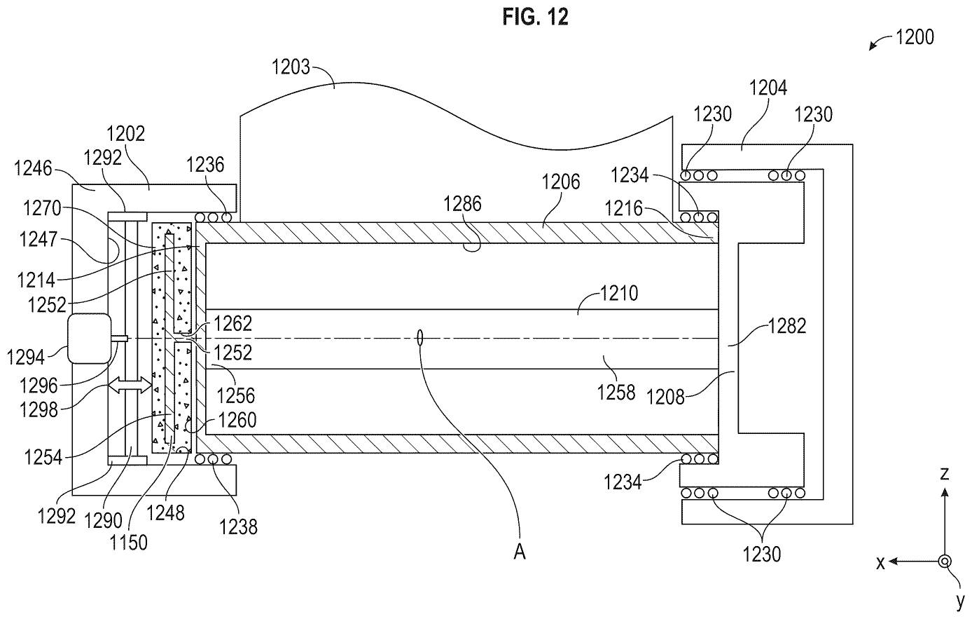

An active and dynamic arrangement refers to an MR or ER system where the activating field strength is manipulated via a power control system (a closed or open loop system) that controls a locating actuator to move a magnet to adjust the field applied to the fluid according to context of an event. This is shown by the implementation of FIG. 12 and also used with a control of FIG. 10.

As a result, the present seatbelt retractor provides a dynamically changeable load limiting retractor where desired load output may be tuned by an electrical/mechanical signal, and is adaptable to changing vehicle inputs and customizable to the unique situation or event at the vehicle. The control of the seatbelt web can change before or even during a severe deceleration or other event at the vehicle. This provides a customizable load limiter output that provides more effective seat belt restraint depending on the occupant based on their size, seating position, event severity, event modality, gender, or any number of algorithmic inputs. Other details are provided below.

The disclosed seatbelt retractor also may be used to slow the retraction as well.

It will be appreciated that while the examples herein are used with a load limiter such as a torsion bar, it will be appreciated that other types of load limiters may be used instead or in addition, or no such load limiter may be present. These examples are explained below.

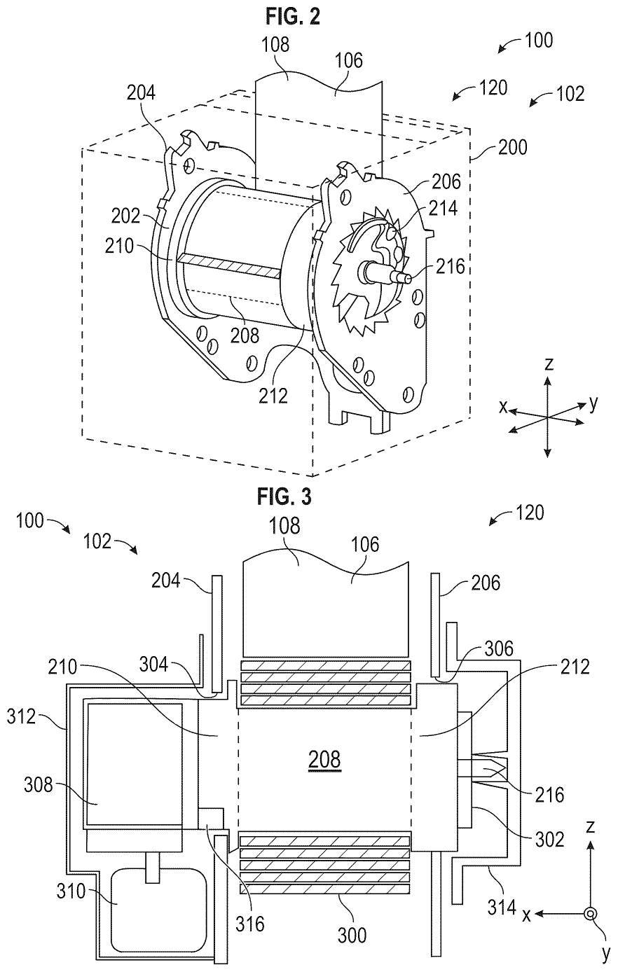

Referring now to FIG. 2 for more detail, the seatbelt retractor 120 may have a housing 200 (shown in dash line) with an example frame 202 that has forward and rear frame portions 204 and 206 respectively here being generally plate shaped and spaced from each other. The frame 202 may be fixed in the housing 200. A spool 208 is rotatably mounted on and between the frame portions 204 and 206, and here shown with the web 108 wound around the spool. The spool 208 is mounted on two opposing outer first and second (or forward and rear) races 210 and 212 that are in turn mounted on the respective frame portions 204 and 206. A locking race (not shown) is mounted within the outer race 212 and has a locking mechanism 214, here including a circular gear, to stop rotation between the locking race and the frame portion 206 (and/or rear outer race 212). The spool 208 may be interconnected to an axle 216 to rotatably hold the spool. The details of the operation of the locking race are described below. It will be appreciated that any mention of forward and rear (such as for sides, races, frame portions, etc.) herein for any implementation is merely to describe components relative to each other and such positioning may be the reverse of what is describe as forward or rear unless context in the language suggests otherwise.

Referring to FIG. 3, the seatbelt retractor 120 is shown here with the same parts numbered as with FIG. 2. In this view, the web 108 is shown wrapped around a spool 208 forming web layers 300. A coil spring 302 (or clock spring) may be mounted on or within one of the races 210 or 212 to bias the retractor 120 to retract the web 108 into the retractor 120 until stopped by a counter force. The outer races 210 and 212 may be respectively mounted within openings 304 and 306 on frame portions 204 and 206 to limit rotation of the outer races relative to the frame 202 and housing 200. A front side of the retractor 120 may hold a damping mechanism 308 such as a chamber of the MR or ER fluid mentioned above as well as an end of a damper within the fluid and that is referred to herein as a restraining portion of the damper (or clutch disc or plate) as described below to slow or stop movement of the web 108.

In this example, a cover or outer frame portion 312 may cover the damping mechanism or unit 308 as well as a lock sensor 310 that may be provided to monitor the status of the spool and lock a locking race to the outer race 212 depending on the motion of the web 108. The opposite side of the retractor 120 may have a cover or outer frame portion 314 to cover the coil spring 302 and provide a rotatable support point (a rotation point bearing, for example) for the end of the axle 216. Also a pawl member 316 may be part of the locking mechanism 214 and selectively connected to the locking race (not shown) within the outer race 212 and communicates with the lock sensor 310 or other controller described below. It should be noted that while the coil spring 302 is on one side of the retractor 120 and a pawl member 316 and locking mechanism 214 (FIG. 2) are on another opposite side of the retractor 120 such as at opposite ends (forward end and rear end) of the retractor 120, these features may be at the same end instead.

Referring to FIG. 4, an example seatbelt retractor 400 is shown in an example first stage 401 of operation of four example stages shown in FIGS. 4-7. The seatbelt retractor 400 is within a housing and frame (not shown here) as described above with seatbelt retractor 120 (FIGS. 2-3). The seatbelt retractor 400 has a spool 406 rotatably mounted on and between a fixed forward race 402 (or first outer race) and a fixed rear race 404 (or second outer race) as with races 210 and 212 described above. The spool may be cylindrical or other desired shape. A seatbelt web 403 is attached to the spool 406 by known techniques, whether fastener, adhesive, mechanical connection such as knot and grooves, and so forth, and for winding the web 403 around the spool 406. It will be appreciated that the forward-rear position of the forward and rear outer races 402 and 404 may be the opposite of that shown, or the outer races 402, 404 may have different positioning than forward and rear.

The spool 406 has a first or forward end 414 that rotates relative to, or within, the forward race 402, and here by ball bearings 436 and 438 between the forward race 402 and the forward end 414 of the spool 406, although alternative structures could be used instead. In this example, a rear end 416 of the spool 406 is rotatable within a locking race 408 by ball bearings 434, while the locking race is in turn rotatable within the rear outer race 404, also by ball bearings 430, although alternative rotatable structures may be used instead. The spool 406 may rotate about an axis A (which here is parallel to the x-axis), and the spool is substantially or generally axially fixed between the locking race 408 and the forward outer race 402 as held by a frame similar to the frame 202 (FIGS. 2-3) for example. In this case, the rear end 416 of the spool 406 is not fixed to the locking race 408 so that the spool 406 is free to rotate either with the locking race 408 when the locking race is not locked, or relative to the locking race 408 once the locking race 408 is rotationally locked. The locking race 408 may be axially fixed within the outer rear race 404 by any suitable connection.

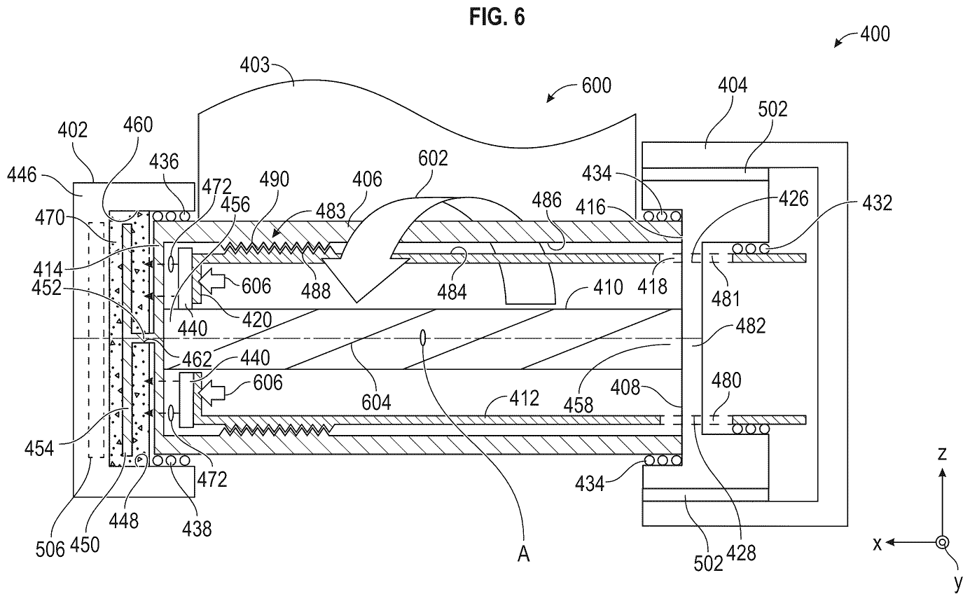

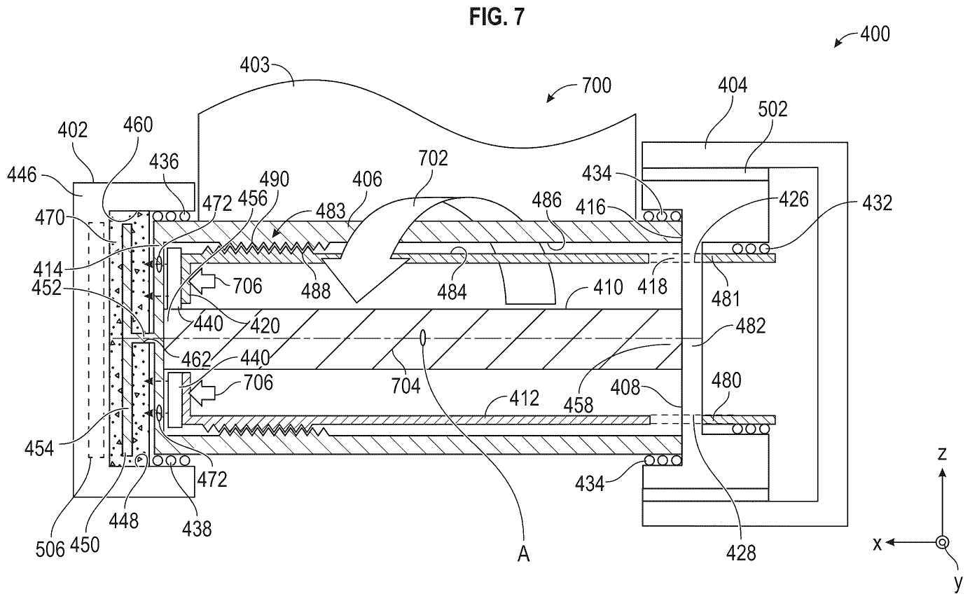

The retractor 400 also has a load limiter such as a torsion bar 410 (or torsion tube or torque tube) with a forward or first end 456 fixed to the forward end 414 of the spool and a rear or second end 458 fixed to the locking race 408. When the locking race is unlocked the torsion bar 410, locking race 408, and spool 406 may rotate together as a single unit. When the locking race 408 is rotationally locked, however, additional rotation of the spool 406 relative to the locking race 408 will cause the torsion bar 410 to twist (as shown in FIGS. 6 and 7) because the forward end 456 of the torsion bar 410 is fixed to the rotating spool end 414 while the rear end 458 is rotationally fixed with the locking race 408. The operation of the locking race 408 is explained below.

As to the torsion bar 410, and during a sudden deceleration or other actual or potential sudden movement of the vehicle, the seatbelt retractor 400 locks tight against the occupant to avoid forward motion of the occupant that could permit the occupant to undesirably contact other objects or experience undesired gravitational forces (Gs). As mentioned above, in this case, the seatbelt web 403 may exert too much force again the occupant. The load limiter, in this case being the torsion bar 410, will permit some extension or payout of the web 403 to reduce this force against the occupant. Thus, when the occupant load induced on the seatbelt retractor 400 exceeds a specific predetermined load, the internal mechanical torsion bar 410 will deform and twist thus providing payout to the seatbelt and limit the increase of load induced on the occupant.

More precisely, the torsion bar 410 twists when subjected to torque and is provided to absorb and moderate the force exerted on the web 403 during a high velocity or high acceleration event, allowing for controlled extension of the belt to reduce forces against the occupant wearing the seatbelt. Specifically, when a seatbelt extends rapidly, the speed is proportional to the force exerted on the belt. This is because the rapid deceleration of the vehicle causes a large inertial force to act on the occupant, which translates into tension in the belt. This is expressed in Newton's Second Law: where the force on the occupant and belt is F=m·a where m is the occupant's mass and a is the deceleration. A higher deceleration (associated with rapid speed change) results in a higher force, which in turn causes the torsion bar to twist more. The rapid extension of the seatbelt (high speed) occurs because a large force is applied due to the occupant's inertia.

With this in mind, selectively adjusting or slowing the rotation of the spool permitted by the torsion bar by use of the MR or ER fluid thereby establishes a retractor 400 that can vary the rotation of the spool, and in turn extension of the seatbelt, depending on the velocity of the web 403 as the web is extending. Although more precisely, the acceleration or force against the occupant are the direct determinative parameters, these are represented by the velocity when the acceleration may be determined or assumed based on a measured velocity of the web 403. Thus, this arrangement of the torsion bar limiting feature helps manage occupant energy by reducing the chest load and peak deceleration G's the occupant head and chest are subjected to.

This velocity context also inherently factors the context of the occupant size as well. Specifically, a larger occupant with a larger mass will result in more kinetic energy than a smaller person, and will cause a higher velocity of the web than a smaller person. Thus, the higher velocity of the web also may indicate a larger occupant.

In order to provide a customized amount of web extension that is more effective or better balanced for a particular situational context, the retractor has a damper to provide variable extension lengths of the web. Thus, the present retractor may provide an extension length and yield force that may change depending on differences in characteristics of the occupant, the vehicle, or the situation/event itself.

Specifically for retractor 400, a damper 450 is provided to automatically adjust for velocity of the web 403 while the locking race 408 is locked and the torsion bar 410 is twisting to permit the web 403 to extend. This is considered a passive and dynamic arrangement as described above. To accomplish this, the forward race 402 has a body 446 whether integral with the forward race 402 or a separate component adjacent the forward race 402. The body 446 forms a damping or rheological fluid chamber 448 with walls 460 either integrally formed by the body 446 or may be a separate tank with a material different than the body 446 and race 402.

The damper 450 may have a stem 452 extending outward from the forward or distal end 414 of the spool 406 and widening into a restraining portion 454 in the shape of a plate or disc, but may have other shapes as desired. The stem 452 extends through a bore 462 formed by the body 446 and that opens into the chamber 448. The restraining portion 454 is within the chamber 448 and is within or in contact with the fluid 470. By one form, the restraining portion 454 may be entirely embedded within the fluid 470.

The term rheological as used herein refers to a material with properties that change when an energy (or force) is applied to the material. As mentioned, this includes the MR and ER fluids, but may include a mechanical application of energy or force as well. By the present example form, the MR fluid 470 used herein exhibits a shear strength which is proportional to the magnitude of an applied magnetic field. Thus, the MR fluid may experience property changes, such as molecular alignment, of several hundred percent within a couple of milliseconds. Such suitable MR fluid materials include ferromagnetic or paramagnetic particles dispersed in a carrier, e.g., in an amount of about 5.0 volume percent (vol %) to about 50 vol % based upon a total volume of MR composition. Suitable particles include iron; iron oxides (including Fe2O3 and Fe3O4); iron nitride; iron carbide; carbonyl iron; nickel; cobalt; chromium dioxide; and combinations comprising at least one of the foregoing; e.g., nickel alloys; cobalt alloys; iron alloys such as stainless steel, silicon steel, as well as others including aluminum, silicon, cobalt, nickel, vanadium, molybdenum, chromium, tungsten, manganese and/or copper.

The particle size should be selected so that the particles exhibit multiple magnetic domain characteristics when subjected to a magnetic field. Particle diameters (e.g., as measured along a major axis of the particle) can be less than or equal to about 1,000 micrometers (μm) (e.g., about 0.1 micrometer to about 1,000 micrometers), or, more specifically, about 0.5 to about 500 micrometers, and more specifically, about 10 to about 100 micrometers.

The viscosity of the carrier can be less than or equal to about 100,000 centipoise (cPs) (e.g., about 1 cPs to about 100,000 cPs), or, more specifically, about 250 cPs to about 10,000 cPs, or, even more specifically, about 500 cPs to about 1,000 centipoise. Possible carriers (e.g., carrier fluids) include organic liquids, especially non-polar organic liquids. Examples include oils (e.g., silicon oils, mineral oils, paraffin oils, white oils, hydraulic oils, transformer oils, and synthetic hydrocarbon oils (e.g., unsaturated and/or saturated)); halogenated organic liquids (such as chlorinated hydrocarbons, halogenated paraffins, perfluorinated polyethers and fluorinated hydrocarbons); diesters; polyoxyalkylenes; silicones (e.g., fluorinated silicones); cyanoalkyl siloxanes; glycols; and combinations comprising at least one of the foregoing carriers.

Aqueous carriers also can be used, especially those comprising hydrophilic mineral clays such as bentonite or hectorite. The aqueous carrier can comprise water or water comprising a polar, water-miscible organic solvent (e.g., methanol, ethanol, propanol, dimethyl sulfoxide, dimethyl formamide, ethylene carbonate, propylene carbonate, acetone, tetrahydrofuran, diethyl ether, ethylene glycol, propylene glycol, and the like), as well as combinations comprising at least one of the foregoing carriers. The amount of polar organic solvent in the carrier can be less than or equal to about 5.0 vol % (e.g., about 0.1 vol % to about 5.0 vol %), based upon a total volume of the MR fluid, or, more specifically, about 1.0 vol % to about 3.0%. The pH of the aqueous carrier can be less than or equal to about 13 (e.g., about 5.0 to about 13), or, more specifically, about 8.0 to about 9.0.

When the aqueous carriers comprise natural and/or synthetic bentonite and/or hectorite, the amount of clay (bentonite and/or hectorite) in the MR fluid can be less than or equal to about 10 percent by weight (wt %) based upon a total weight of the MR fluid, or, more specifically, about 0.1 wt % to about 8.0 wt %, or, more specifically, about 1.0 wt % to about 6.0 wt %, or, even more specifically, about 2.0 wt % to about 6.0 wt %.

Optional components in the MR fluid 470 include clays (e.g., organoclays), carboxylate soaps, dispersants, corrosion inhibitors, lubricants, anti-wear additives, antioxidants, thixotropic agents, and/or suspension agents. Carboxylate soaps include ferrous oleate, ferrous naphthenate, ferrous stearate, aluminum di- and tri-stearate, lithium stearate, calcium stearate, zinc stearate, and/or sodium stearate; surfactants (such as sulfonates, phosphate esters, stearic acid, glycerol monooleate, sorbitan sesquioleate, laurates, fatty acids, fatty alcohols, fluoroaliphatic polymeric esters); and coupling agents (such as titanate, aluminate, and zirconate); as well as combinations comprising at least one of the foregoing. Polyalkylene diols, such as polyethylene glycol, and partially esterified polyols can also be included.

Electrorheological (ER) fluids are similar to MR fluids in that they exhibit a change in shear strength when subjected to an applied field, in this case a voltage rather than a magnetic field. Response is quick and proportional to the strength of the applied field. It is, however, an order of magnitude less than that of MR fluids and several thousand volts are typically required.

The tank or chamber 448 should have walls 460 that are impermeable to the MR or ER fluid, and that are chemically inert and resistant to the fluid. This may include materials such as metals as with stainless steel or aluminum with high-quality seals or non-porous polymers such as PTFE (Teflon) or reinforced composites, depending on temperature and pressure conditions.

The bore 462 also may have a sealant or seal arrangement to limit leakage of the MR or ER fluid. This may include a dynamic seal such as O-rings with or without backup rings, rod seals such as those made from elastomers or PTFE composites, lip seals such as elastomeric seals with a dynamic lip that interfaces tightly with the rotating stem, and magnetic fluid seals such as a magnetically confined fluid seal where a magnetic field may be applied around the bore 462 to hold the MR fluid in place. Other alternatives include magnetic brush seals that uses a magnetic field to suspend fine magnetic particles in the fluid 470. Other options include bellows or flexible elastomeric boot bellows that enclose the stem, and metal bellows. Other alternatives may include labyrinth or contactless seals, non-contact magnetic seal, compression packings such as braided packing such as with compressible graphite or PTFE packed into a gland around the stem 452, spring-loaded packings, coatings and clearances such as low-friction coatings applied to the stem 452, and precision clearance seals.

To adjust the web extension amount by controlling the spool 406, the retractor 400 may have a spindle 412 (or inner spindle) rotatable about the axis A and rotationally fixed to the locking race 408. The spindle 412 may be cylindrical or any other desired shape. The spindle 412 is positioned within the spool 406 and is connected with the spool 406 to either rotate with the spool 406 when the locking race 408 is unlocked, and translate axially along axis A and relative to the spool 406 and chamber 448 when the locking race 408 is locked.

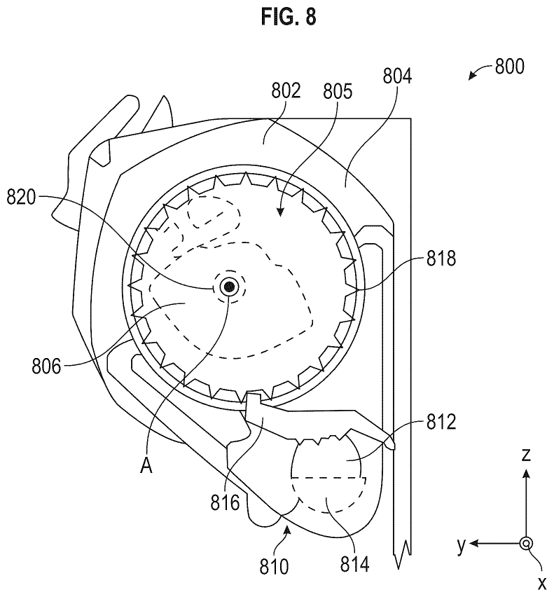

Referring to FIGS. 4A-4B for example, the spindle 412 and locking race 408 are connected to each other with a structure to limit rotation relative to each other while permitting translation of the spindle 412 relative to the locking race 408, such as with a slip or sliding joint. The locking race 408 is shown here with a spool bearing 409 that when extended holds the ball bearings 434 between the locking race 408 and the spool 406 (FIG. 4). A locking bearing 409 is shown here as well and that may hold elements of the locking mechanism 810 (FIG. 8). The spindle-locking race coupling structure includes longitudinally (or axially) extending spindle guides (or columns), here being three spindle guides 480, 481, and 483, although more or less may be used. The guides 480, 481, and 483 of the spindle 412 extend through openings 426 and 428 on a body 482 of the locking race 408 and then end at a terminal portion 487 of the spindle 412. The terminal portion 487 may have the same or similar diameter as the remainder of the spindle 412 and may engage ball bearings 432 (FIG. 4). The spindle 412 may have guide end holder portions 471, 473 that are projections into the spindle that forms a recess to receive an of the guide, and the spindle terminal portion 487 may have guide end holder portions 475, 477 that form recesses at the spindle terminal portion. So arranged, the guides 480, 481, and 483 are rotationally restricted within the openings 426 and 428 thereby restricting the rotation of the spindle 412 to that of the locking race 408 while permitting axial movement of the spindle 412 the length of the columns 480. The guides 480, 481, and 483 here have a cylindrical outer surface and matching recess shapes although other shapes of the guides and openings than cylindrical may be used. Also, the guides 480, 481, and 483 are evenly spaced around the locking race 408, and may be placed through bushing and/or bearing sleeves when desired, although alternative arrangements may be used as well.

The spindle 412 also has a near end 418 adjacent the locking race 408 and an opposite distal end 420 closer to the distal end 414 of the spool 406. The distal end 420 of the spindle 412 has one or more magnets, here being one ring magnet 440 (see FIG. 4A), arranged to emit a magnetic field 472 directed toward the MR fluid 470 in the chamber 448 and horizontally or axially in this example. A connection 483 between the spindle 412 and the spool 406 may be a threaded connection between threads 488 at an outer surface 484 of the spindle 412 and threads 490 at an inner surface 486 of the spool 406. Other connections or fasteners may be used instead as long as the spindle 412 can rotate with the spool 406 when the locking race 408 is unlocked and move axially relative to the spool 406 when the locking race 408 is locked.

The magnet 440 may be used to excite the magnetorheological (MR) fluid 470 and can be made from a range of materials. Permanent magnet options include neodymium-iron-boron (NdFeB) for high-strength compact designs, samarium-cobalt (SmCo) for thermal stability and corrosion resistance, and ferrite magnets for cost-effective solutions with moderate field strength. For variable magnetic fields, electromagnets may utilize soft iron or steel cores to concentrate the magnetic flux, often paired with copper or aluminum wire coils, silicon steel or laminated steel cores.

In normal operation, when the seatbelt web 403 is moving relatively slowly, such as when an occupant is buckling or adjusting the seatbelt or during normal driving of the vehicle without extremely high deceleration or acceleration, etc., the spool 406, spindle 412, and the locking race 408 in an unlocked state will all rotate together. Thus, in this stage 401 (or stage one), the spindle 412 is rotating and is not moving axially. Also, in this stage, the presence of the restraining portion 454 of the damper 450 has the effect of mixing or stirring the MR fluid 470 thereby breaking chains formed by the particles in the MR fluid 470 and agitating the MR fluid 470 to assist with maintaining magnetic particles within the fluid in a suspended condition to provide a more uniform fluid within the chamber 448.

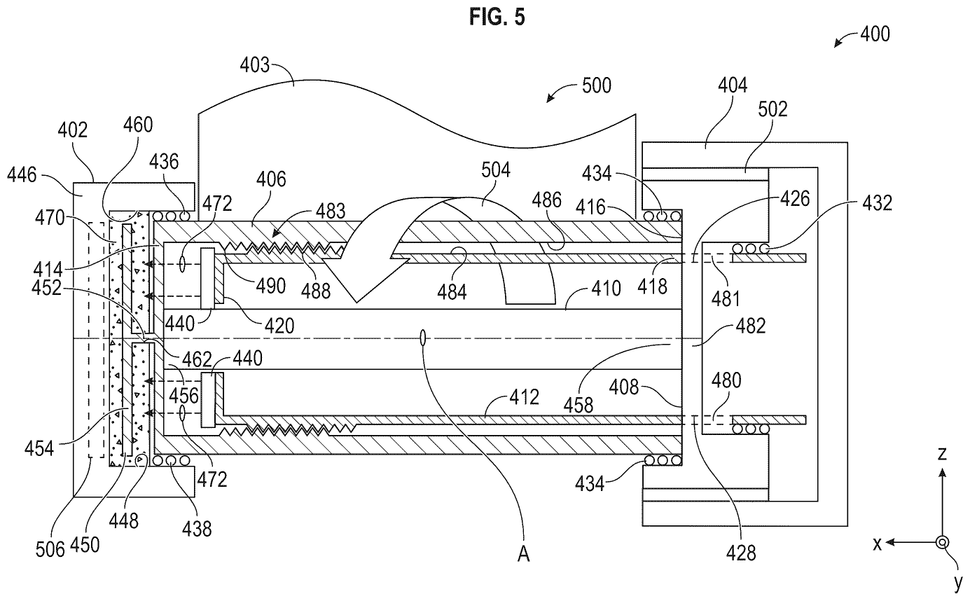

Referring to FIG. 5, an example second stage (stage two or stage 500) of the operation of the seatbelt retractor 400 is shown with the same retractor 400 except now the locking race 408 is in a locked state as represented by a lock position 502 while the spool 406 continues to rotate as shown by arrow 504.

An optional base magnet 506 also is shown here and may be permanently present on retractor 400 but was admitted on FIG. 4 simply for clarity. The base magnet 506 may provide a base magnetic field (not shown) to provide a base viscosity at the fluid 470 when a minimum viscosity and stiffness is desired at the fluid 470 and cannot be present without at least some level of magnetic field. This may be provided when the magnet 440 on the spindle 412 cannot solely provide a magnetic field with sufficient strength for desired web control.

Referring to FIG. 8 for now, the locking of the locking race 408 may be explained with one example frame 802 that has a forward or rear frame portion 804 similar to frame portions 204 or 206 described above, and here of an example seatbelt retractor 800. The retractor 800 has a locking device or mechanism 810 that may have or be a seatbelt web speed sensor, and which here specifically may be a ball sensor although other types of locking devices may be used. In this example, the locking mechanism 810 detects rapid acceleration or deceleration of the seatbelt web. By one form, when the locking mechanism 810 is a ball sensor, the ball sensor may have a small metal or plastic ball 812 that is held in a ball holder 814 such as a ball cage or track. With this arrangement, the ball remains in a stable position on the ball holder 814 when typical relatively slow extension or retraction of the seatbelt occurs due to a person moving the seatbelt, usual driving conditions, and so forth. A pawl 816 (or locking lever) is rotatably mounted to the ball holder 814 and remains disengaged from a ratchet gear 805 with teeth 818 and that is rotatably fixed to the locking race such as locking race 408, not shown here because it is on the opposite side of the frame portion 804.

When the deceleration or acceleration of the vehicle is sufficiently high to indicate large loads will be directed to the occupant of the seat (such as during sufficiently sudden brake application or contact between the vehicle and other objects), the inertia from this event will cause the ball 812 to move out of its resting position in the holder 814 and move axially (here into the paper in the A axis or x-axis direction). The ball 812 will engage the underside of the pawl 816. The pawl 816 has an underside (not shown) slanted so that the forward motion of the ball 812 will push the pawl 816 into engagement with the teeth 818 of the ratchet gear 805 thereby locking the ratchet wheel 805 and in turn the locking race 408. Alternatively, the ball 812 may interact either directly or indirectly through interconnectors with the pawl 816 or other trigger mechanism, which shifts the pawl 816 into a lock position.

Alternatively in a speed-based seatbelt locking mechanism, the components may correspond to elements of a planetary gear system or a similar inertial locking arrangement. In this case, the ratchet gear 805 instead is an internal gear or ring gear fixed to the frame portion 804, while a central piece 820 such as a sun gear or core spindle acts as the primary rotating piece in the system. A non-concentric irregularly-shaped and donut-shaped middle piece (or locking cam or inertial sensor ring) 806 is fixed to the locking race 408 and rotates with the locking race 408. The locking cam 806 rotates as the locking race rotates and has its own teeth that will lock with the teeth of the internal gear 805 under certain circumstances caused by high deceleration and other events.

Referring again to FIG. 5, once the locking race 408 is in a rotationally locked state and the spool 406 continues to rotate, the spindle 412 also is in a rotationally locked state with the locking race 408. The spool 406 is still permitted to rotate in this locked state. However, the locked state causes the torsion bar 410 to begin to deform or twist while the threaded connection 483 between the spool 406 and the spindle 412 shifts the spindle 412, and in turn the magnet 440, axially toward the chamber 448 and MR fluid 470. This is shown by FIG. 6 for a stage three (or stage 600), where the continued rotation 602 of the spool 406 and the twist 604 of the torsion bar 410 are shown causing the axial shift 606 of the spindle 412 and magnet 440 toward the chamber 448 and MR fluid 470.

In this stage three (600 of FIG. 6), the magnet 440 is increasing the strength of the magnetic field 472 as the magnets approach the chamber 448 and are causing the MR fluid to increase in viscosity (or become more viscous) and become stiffer creating a stronger brake on the restraining portion 454 of the damper 450. This increasingly slows the rotation of the spool 406 and in turn extension of the web 403 more as the velocity of the web 403 increases and the torsion bar 410 twists more, thereby providing a dynamic or adjustable response to context, here the context being the velocity of the web 403 (and possibly the size of the occupant). This direct control of the rotation of the spool 406 by the MR or ER fluid via the damper 450 is referred to as a clutch arrangement.

Referring now to FIG. 7. an example fourth stage of operation of the seatbelt retractor 400 is shown where the maximum axial shift 706 of the spindle 412 has occurred, thereby exerting a magnetic field 472 at maximum strength. This may happen when loads are extremely severe, and the additional spool rotation 702 further twists the torsion bar 410 into a twist 704. By the end of the inner spindle's travel, the strength of the magnetic field will peak along with the capability of the damper 450.

Referring now to FIGS. 9-12, the seatbelt retractors for FIGS. 9-12 may have a similar arrangement as with retractor 400 where the damper is formed at an end of the spool with a load limiter torsion bar. In these cases, however, the retractor may use a damping control and a field generator or magnet actuator to selectively position or adjust a magnetic field near the chamber and MR or ER fluid. These are considered active arrangements. This permits more context elements (or characteristics or features) to be factored into generating the strength of the MR or ER field and in turn provide more nuanced or customized control of the seatbelt web to obtain a better balance between protecting the occupant from objects and high acceleration or deceleration (Gs) versus providing payout (or extension or slack) to reduce forces from the seatbelt itself. While the alternative arrangements of FIGS. 9-12 do not use the inner spindle described above, it will be understood that the following arrangements may add the spindle to the externally controlled, active alternatives of FIGS. 9-12. Also, these implementations as well as any of the implementations herein may omit the torsion bar when precise control of the spool rotation can be maintained without the torsion bar and by use of the external controls mentioned herein or any other control.

Referring to FIG. 9, a seatbelt retractor 900 has many of the same or similar components numbered similarly as seatbelt retractor 400, and need not be described again. As mentioned, no inner spindle is provided in this alternative, although the inner spindle may be used when desired. Instead of magnets on an inner spindle, the retractor 900 has a field generator 998 on the outer forward race 902 or body 946. The retractor 900 operates as explained with retractor 400 except without the inner spindle to automatically move magnets. Instead, the field generator 998 may be coupled to a seatbelt retractor damper system 1000 (FIG. 10) for control of the field generator 998.

Referring to FIG. 10, the system 1000 may be a separate application or may be part of a larger vehicle seatbelt system, event response, and/or vehicle monitoring system. The seatbelt retractor damper system 1000 has a seatbelt retractor damper control (SRDC) 1002, also referred to as a damping control, to receive sensed and/or stored data relating to context factors to be considered to set a field strength by the field generator 998 or here 1028. The SRDC 1002 may have a data acquisition unit 1014, one or more processors 1016 to operate any of the units of the seatbelt retractor damper system 1000, memory to store the applications, operations, and context data of any of the units of system 1000, a retractor dynamic load limiter force unit 1020, a force to power conversion unit 1022, and a power supply 1024.

The SRDC 1002 may receive context data from a spool sensor unit 1004 when provided with the implementation of FIG. 11 (below), a seatbelt load cell unit 1006, a vehicle monitoring unit 1008, an Advanced Driver Assistance System (ADAS) 1010, and an occupant monitoring unit 1012. Other monitoring, sensing, and data collection context factors may be used that are not mentioned here.

The system 1000 also may include a damper 1026 which here includes a fluid coupler 1030, which is the restraining portion of the dampers 450 or 950 (or 1150 (FIG. 11) or 1250 (FIG. 12)). The damper 1026 here also may include the field generator 1028 (or 998, 1198, or 1298) that is on the forward race in these examples.

In the example of system 1000, the SRDC 1002 receives context data from the context factor units 1004 to 1012 and any others not shown. The SRDC 1002 has the data acquisition unit 1014 to receive, organize, and analyze the context data to place the data into useful and expected formats or forms. Context data also may be obtained from the memory 1018 that may have a database of previously stored context data. The context data then may be provided to a retractor dynamic load limiter force unit 1020 to generate desired MR or ER field levels or energy levels to apply to the MR or ER fluid. These levels are then provided to a force-to-power conversion unit 1022 to convert the levels to power levels for generating the MR or ER fields. The power levels are then provided to the power supply unit 1024 to transmit the target or desired power to the field generator 1028, which then generates the MR or ER field at the desired strength and to be directed to the MR or ER fluid 470 or 970 (or 1170 or 1270).

Now in more detail, since the processor 1016 performs the computation and control functions of the SRDC 1002, the SRDC 1002 may comprise any type of processor circuitry forming one or more processors, processor cores, single integrated circuits such as a microprocessor, processors on systems on a chip (SoC), or any suitable number of integrated circuit devices, processor circuitry, and/or circuit boards working in cooperation to accomplish the functions of a processing unit.

The context data units 1004 to 1012 may have their own processors and, hardware, and firmware in addition to the software indicated, but also may share the processor(s) 1016. Otherwise, the processors 1016 may operate the units 1014, 1020, 1022, and 1024 with any combination of hardware, firmware, and/or software.

The memory 1018 may be any type of suitable memory. For example, the memory 1018 may include various types of dynamic random access memory (DRAM) such as SDRAM, the various types of static RAM (SRAM), and the various types of non-volatile memory (PROM, EPROM, and flash). In certain examples, the memory 1018 is located on and/or co-located on the same computer chip as the processor 1016. In the depicted implementation, the memory 1018 stores the programs of any of the units mentioned on system 1000. The memory 1018 also may include one or more databases to store context data or programs as mentioned above.

As to the context data, the seatbelt load cell unit 1006 provides sensor data from seatbelt load cells at the seatbelt system, and providing tension and other forces transmitted through the seatbelt system. These sensors may be placed at the base of the buckle where the latch tongue engages, along the seatbelt web, such as near the D-ring (or pillar loop) or retractor, or other anchor points such as near the end buckle.

The vehicle monitoring unit 1008 collects and provides both current (or real time data) as well as predetermined data. The predetermined data may include relevant interior cabin specifications and dimensions. The current data may include anything being monitored including the speed of the vehicle, a current seat position relative to the dashboard, the seat back angle, automatic emergency braking (AEB) system status, status of other configurable cabin conditions such as a tray table position, etc.

Data of specific sudden motion events may be obtained from the vehicles event monitoring systems such as the supplemental restraint system (SRS), and specifically the airbag system and the sensing and diagnostic module (SDM) system. These systems can provide data on event severity, event modality, and an event pulse. The event severity sensors may measure and compute deceleration rates, contact forces, and resulting damage to components on the vehicle. The deceleration rates may be measured in terms of acceleration (G-forces) or delta-V (change in velocity during the event). The event modality sensors measure or compute the classification or label of contact with the vehicle (e.g., frontal, rear, etc.). The event pulse data includes time-history profiles of the forces or accelerations experienced by the vehicle during contact with another object and may include peak forces, duration, rate of deceleration, or energy absorption, these can be used to set the appropriate retractor load.

The ADAS unit 1010 may provide real-time sensor data predicting or indicating upcoming contact (incoming target) between the vehicle and another object by tracking the other objects near the vehicle that are traveling with high velocity such that contact is imminent. These may provide data on the incoming target velocity, incoming target mass, and incoming target trajectory whether directly by sensors or estimations by image processing with computer vision by using the vehicle's camera array for example.

The occupant monitoring unit 1012 provides sensor data indicating the characteristics or features of the occupants of the vehicle. This may include detecting the occupant anthropomorphic data such as measurements and attributes that relate to the human body's size, shape, posture, gender, and so forth. This may include detecting the frailty of an occupant by using sensors to detect the body mass compared to the body size thereby deducing bone mass and age including occupant size classes (such as child, infant, 3-6 YO, 10 YO, adult (5^{th}, 50^{th}, 95^{th}) and/or size by weight on a continuum. Also, three dimensional occupant pose can be detected by sensors used to determine whether hands are on the steering wheel, legs on the dashboard, body is slouched and/or leaning against cabin panels (such as on the doors) or other interior parts of the vehicle, proximity of the occupant to an airbag (AB), sleep seat detection, high or low recline of the seatback, and so forth. An occupant location may be detected as a designated seating position (DSP) that indicates the type and arrangement of restraints being used, on, or worn by the occupant such as whether the front and/or side airbags are armed, etc.

The spool sensor unit 1004 monitors the movement of the retractor spool, thereby measuring the velocity of the seatbelt web directly rather than, or in addition to, inherently relying on the amount of deformation or twist at the torsion bar of the retractor. As shown, the spool sensor unit 1004 may receive continuous feedback from monitoring a spool 1034 on a retractor 1032.

The context factor data from any of these units may be provided to the SRDC 1002 by any suitable data communications circuit or network, whether from separate or shared systems on the vehicle itself, satellite, computer, cellular, or 5G network, whether wired, wireless, or some combination, including a wide area network (WAN) including the Internet and cloud networks and servers, local area network (LAN), personal area network (PAN) including Bluetooth, and so forth.

The context factor data collection may be performed continuously, at intervals, and/or when a recognized potential event is predicted to occur, or an actual event is occurring.

Once the factor data is collected and formatted by the data acquisition unit 1014, the retractor dynamic load limiter force unit 1020 computes the energy to be applied to the MR or ER fluid, and in turn, the strength of the magnetic or electric field to be applied to the MR or ER fluid. This may be accomplished in a number of ways. First, predetermined models may form direct relationships with the energy and field settings. For example, a certain occupant weight may indicate a specific energy or field to be applied to the MR or ER fluid. This may apply to many of the context factors mentioned herein. This also may include when multiple different factor value combinations are combined, such as with a certain occupant weight plus a large external object detected that has a heading toward the vehicle at a specific angle and with a laptop or other object detected on the lap of the occupant who is in front of an armed airbag. This may indicate a energy or field value to apply to the fluid and to achieve a best balance of most likely least force and harm to the occupant. Thees predetermined models may be stored in a database accessible by the retractor dynamic load limiter force unit 1020.

Whether such analysis is predetermined or determined on the fly (in real time or near real time) during an event, and whether for a single context factor or some combination of factors, such modeling may include a number of different algorithms. For example, adaptive control algorithms may be used such as Proportional-Integral-Derivative (PID) control to dynamically adjust energy based on inputs mentioned above. Fuzzy logic algorithms may be used to manage uncertainties and variability in sensor data, enabling fine-tuned adjustments to the load limiter. The use of pre-trained neural networks or machine learning algorithms can be used for many different tasks. For example, machine learning algorithms, such as reinforcement learning or the neural networks, may be used to analyze historical event data and real-time sensor inputs to predict an optimal load-limiting energy. Additionally, rule-based algorithms might use predefined thresholds for vehicle deceleration, belt tension, or occupant biometrics to adjust the energy. Kalman filters may be used to process noisy sensor data, ensuring the algorithms receive accurate input for decision-making. Any one or more of these techniques may be used as well as many others not mentioned here. The output may be a target energy level or target magnetic or electrical filed strength to be applied to the MR or ER fluid.

The force-to-power conversion unit 1022 converts the energy or field strength output to the corresponding activating power, and may be provided as a modulated signal. A modulated activating field results and may be based on how fast the payout is occurring, how far the payout has already extended, and how urgent is the need to slow or stop the payout, such as when an end of the belt is approaching.

The power supply1024 then receives the target power activation levels and delivers the target activating power to the field genera tor 1028 that converts the current flow into an electromagnetic field that activates and energizes the variable-rheological fluid. A magnetic field generator 1028 may have a copper coil, such as a solenoid, wrapped around a core to create an electromagnet. The core may be made of ferromagnetic materials such as iron, nickel, or specialized alloys such as silicon steel. Alternative magnetic field generators may be used instead.

An electric field generator may have a voltage source, electrodes, and a dielectric medium to shape and enhance the field. The voltage source provides the potential difference required to generate the field, while the electrodes may be made of a conductive material such as copper or aluminum to provide terminals where the field emanates. The dielectric medium may be made of ceramics or polymer composite to prevent current from flowing between the electrodes while allowing the field to propagate effectively. Capacitors may be used to stabilize or amplify the field.

The generated field then may energize the MR or ER fluid to stiffen against a fluid coupler 1030. Such fluid coupler 1030 may be a restraining portion of a damper that is connected to a retractor spool or plunger as mentioned herein. In other words, the energized fluid provides a rotation-opposing energy (and in turn force) to the retractor spool for retractor 400 or a translation opposing energy for the plunger arrangement in retractor 1300 described below.

Referring again to FIG. 9, the retractor 900 is provided to represent a static input system or device. In other words, the field generator 998 may be set to generate a single uniform field strength that is maintained during vehicle use or is at least maintained during the occurrence of an event. The field strength may be predetermined before vehicle use by making assumptions as to the conditions and context to be used at the vehicle, such as average occupant size, and so forth. Otherwise, the field strength may be set upon detection of an initial context at a vehicle and then maintained during the use of the vehicle for a certain duration or until a certain trigger occurs, such as the vehicle being turned off and then restarted, although many different triggers may be used. Many other examples may be used. By one example, context data of a quasi-static input signal such as an Advanced Occupant Sensing (AOS) system may be used to set a fixed potential load output to reduce forces against an occupant.

Otherwise, a dynamic system may be used that continuously analyzes received context factor data as feedback or updates, and when available even during a sudden motion or deceleration/acceleration event. Thus alternatively, the retractor 900 may change a potential or actual load output based on feedback or updated input signals thereby establishing a feedback loop. As one example, this alternative arrangement provides a programable stiffness output, and the output can be dynamically changed during an event such as initially having a relatively smaller brake energy and permitting a larger load against the occupant, but then provide a larger brake energy and softer or less load against the occupant for an event with a longer duration or when a smaller occupant is detected.

Referring to FIG. 11, a seatbelt retractor 1100 is similar to seatbelt retractor 400 and 900, and has components numbered similarly that do not need to be described again. The retractor 1100 has a field generator 1190 similar or the same as field generator 998 and 1028 (FIG. 10) such that the operation is the same or similar. Here, however, the retractor 1100 has a spool sensor 1192 monitoring the position and speed of the spool 1106 (or 1034 on FIG. 10) to provide spool sensor data to the spool sensor unit 1004 (FIG. 10) to be used as context data. Thus, in this case, the velocity of the web 1103 retracting onto, or extending from, the spool 1106 is a measurement that can be used as a context factor rather than simply inherent to the amount of spool rotation or torsion bar twist.

Referring to FIG. 12, a seatbelt retractor 1200 is similar to seatbelt retractor 400, 900, and 1100, and has components numbered similarly that do not need to be described again. Here, however, the retractor 1200 has a magnet locating actuator 1294 on the body 1246 and/or race 1202 rather than the field generator. In this case, the body 1246 of the forward or first race 1202 has a cavity 1247 adjacent or in proximity to the fluid 1270. The chamber 1248 may be integrally formed in the body 1246 or may have its own walls 1260 to form a tank, which may or may not be disposed in the cavity 1247. A movable exciting magnet 1290 may be located in the cavity 1247 to translate axially in the A-axis direction within the cavity 1247 and by being attached to guides 1292 such as tracks to guide the magnet 1290 as it translates toward or away from the chamber 1248 and within the cavity 1247. It will be appreciated that other guides than tracks may be used instead, and any suitable mechanism to maintain the alignment of the magnet in the direction of the A-axis may be used. The magnet locating actuator 1294 may have a control rod 1296 to push or pull the magnet 1290 into a desired position with a desired distance from the chamber 1248 to apply a predetermined field strength to the MR or ER fluid 1270 in the chamber 1248. The magnet locating actuator 1294 may use a pressure plate, mechanical cord, ratchet and/or gears attached to magnet control rod 1296, or other suitable mechanism to move the magnet 1290. The magnet locating actuator 1294 may be communicatively and operatively coupled to the damping control system 1000 to operate the magnet locating actuator 1294 and position the magnet 1290 depending on context factors as described above. In operation, the magnet may be moved axially as shown by arrows 1298, and the closer the magnet is placed to the chamber, the stronger the magnetic field applied to the MR fluid 1270 in the chamber 1248, and in turn, the stronger the braking pressure on the restraining portion 1254 of the damper 1250 to stop or slow the spool 1206.

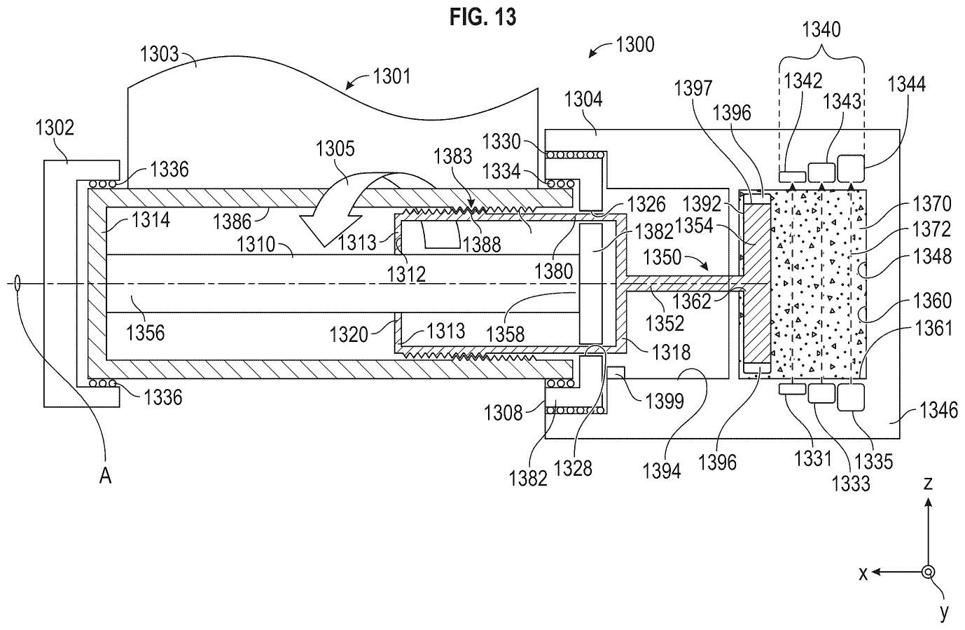

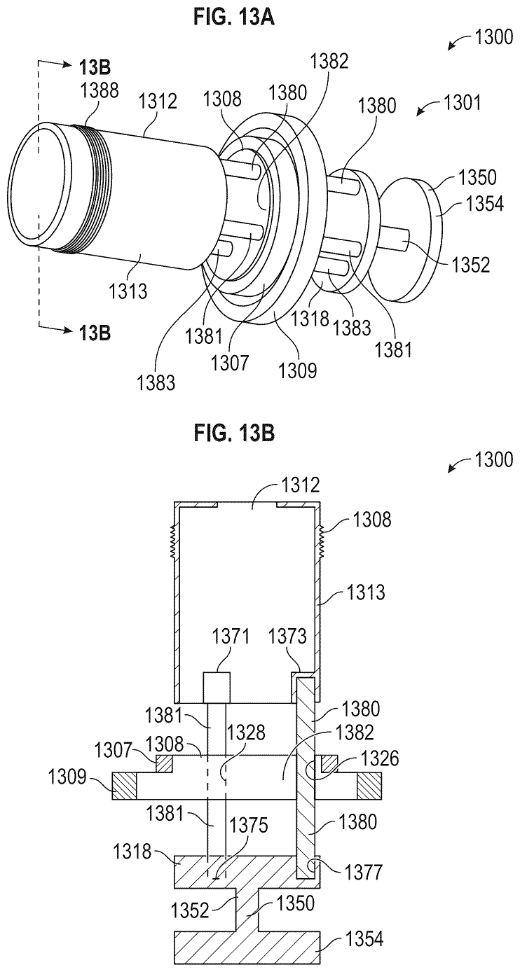

Referring to FIG. 13, an example seatbelt retractor 1300 has a plunger arrangement rather than the clutch arrangement of the retractors 400, 900, 1100, and 1200 described above. Here, rather than an inner spindle with magnets being moved to adjust the field strength applied to the MR fluid within a chamber, a plunger or piston is moved axially to move a restraining potion of a damper near magnets of different field strength that are adjacent the sides of the fluid chamber instead.

More specifically, the retractor 1300 has a spool 1306 rotatably mounted on and between forward and rear outer races 1302 and 1304 to wind and unwind a seatbelt web 1303. The spool 1306 may be cylindrical or a different desired shape. A locking race 1308 is at the rear outer race 1304 as with locking race 408 of retractor 400. Ball bearings 1330, 1334, and 1336 permit rotation among the races and spool. A torsion bar 1310 extends from the locking race 1308 to a spool end 1314. A pawl 1399 may be on the outer race 1304 (or retractor frame not shown) to engage a gear (not shown) of the locking race 1308 and rotationally lock the locking race 1308 to the outer race 1304 and in turn a frame similar to frame 202 (FIG. 2) of the retractor 1300. These components are the same or similar to those components numbered similarly and/or with the same labels on retractor 400, such that these components and their operation, need not be described again here.

In this case, however, the rear outer race 1304 has a body 1346 forming or holding an MR or ER fluid chamber 1348 containing an MR or ER fluid 1370. Thus, walls 1360 of the chamber 1348 may be integral with the body 1346 of the outer race 1304 or be a separate material to form a tank within the body 1346. The body 1346 also forms a cavity 1394 to receive a plunger 1312. A dividing wall 1392 separates the cavity 1394 from the chamber 1348 and may be part of body 1346.

The plunger 1312 may have an inner spindle portion 1313 coupled to a damper 1350 with a stem 1352 and a restraining portion 1354. The inner spindle 1313 may be a cylindrical shape and may have a rotatable connection 1383 with the spool 1306 such as a threaded connection with threads 1388 of an outer surface 1384 of the spindle portion 1313 engaging threads 1390 of an inner surface 1386 of the spool 1306. The plunger 1312 also extends axially through the locking race 1308 to be rotationally fixed to the locking race 1308 while being able to translate axially along axis A for a certain range through the locking race 1308.

The spindle portion 1313 has a first or forward end 1320 and a second or rear end 1318, and the stem 1352 extends outwardly and axially from the second end 1318 and to the restraining portion 1354. As with the similar restraining portion 454, the restraining portion 1354 also may be plate or disc shaped, but may be other shapes as desired.

Referring to FIGS. 13A-13B, a slip or sliding joint between the spindle portion 1313 of the plunger 312 and the locking race 1308 also may have a number of different arrangements. One may be similar to that the slip joint of FIGS. 4A-4B described above, and the elements are numbered similarly such that much of the description is already provided above with retractor 400. Thus, here, three spindle guides 1380, 1381, and 1383 also extend through openings 1326 or 1328 through a body 1382 of the locking race 1308 to translate through the locking race 1308. The guides 1380, 1381, and 1383 also are fixed at their ends within projections 1371 and 1373 on the spindle portion 1313, and to the damper 1350 on at the opposite second end 1318, and specifically within recesses 1375 and 1377 in the second end 1318. Otherwise, the components are as described with FIGS. 4A-4B above except for the damper 1350.

Turning to the damper 1350, the stem 1352 extends through a bore 1362 through the dividing wall 1392 so that the restraining portion 1354 is positioned within the chamber 1348 and is in contact with, or embedded within, the MR or ER fluid 1370. The bore 1362 is sealed within the chamber 1348 as mentioned above on retractor 400.

The body 1346 and/or outer rear race 1304 may have an array or set 1340 of multiple activating magnets 1342-1344 positioned along the axial or A-axis direction at one or more sides 1361 of the chamber 1348. The magnets may be in a straight array or other alignment, and may have a single magnet or multiple magnets at a single axial position. Thus, as shown, each axial position may have two separate magnets (for example, 1342 and 1331), or a single magnetic ring encircling the chamber 1348 where magnets 1342 and 1331 are part of the same ring magnet. Many variations may be used. In the present example, the magnets 1342-1344 and 1331-1335 increase in magnetic field strength as the magnet is positioned farther to the right or rearward. The magnets 1342-1344 and 1331-1335 may be embedded within the body 1346 and inward from the sides 1361 so that the magnets remain out of contact with the fluid 1370 in the chamber 1348. This may be accomplished by using larger magnets or magnets of the same size but varying materials to increase magnetic field strength. With this arrangement, the MR fluid will be more viscous and stiffer as the plunger moves more to the right or rear toward the stronger magnets 1344 and 1335.

Optionally, the restraining portion 1354 also may have one or more base magnets 1396 or a single ring magnet at an outer rim 1397 of the restraining portion 1354. The base magnet 1396 provides an initial magnetic field as mentioned above for magnet 506 (FIG. 5).

Referring again to FIG. 13, a first stage 1301 of operation of the retractor 1300 is shown where the web 1303 is moving relatively slowly so that the spool 1306 rotates as shown by arrow 1305 and with the locking race 1308, the torsion bar 1310, and the plunger 1312.

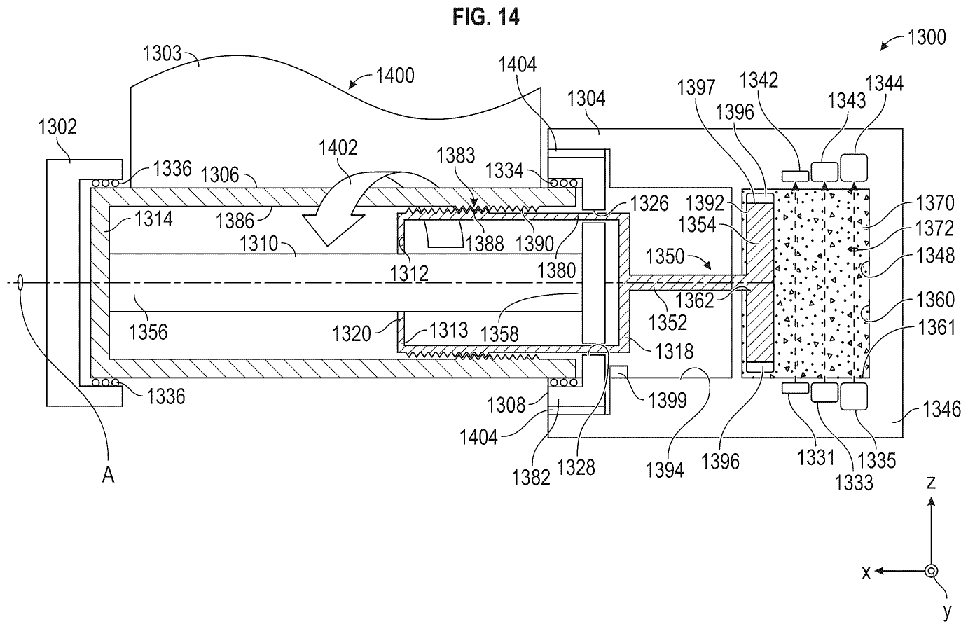

Referring to FIG. 14, a second stage 1400 of operation of the retractor 1300 shows that the web 1303 is now moving sufficiently fast to quickly rotate (by arrow 1402) the spool 1306 and trigger the lock (as represented by the lock of ball bearings at lock 1404) of the locking race 1308. At this point then, the plunger 1312 becomes rotationally locked as well and may begin to move axially to the right or rear due to the threaded connection 1383 with the rotating spool 1306.

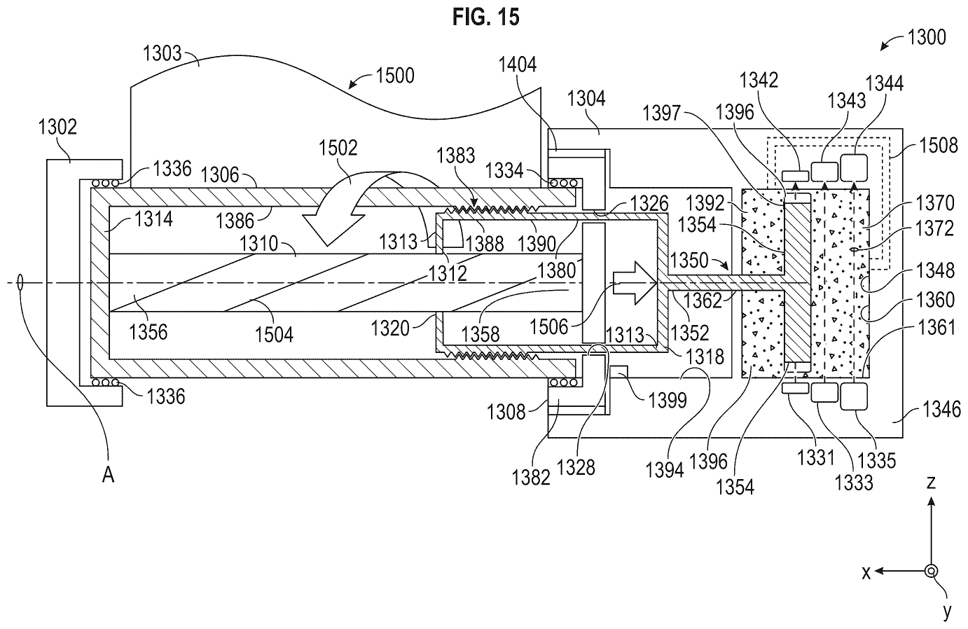

Referring to FIG. 15, a third stage 1500 of operation of the retractor 1300 shows that the web 1303 is now moving sufficiently fast to cause the torsion bar 1310 to deform or twist 1504, thereby permitting the spool 1306 to continue to rotate as with arrow 1502 about the A-axis. This causes the plunger 1312 to move (as shown by arrow 1506) more to the rear or right, which moves the restraining portion 1354 near or past the magnets 1342-1344 and 1331-1335 thereby increasing the activating magnetic field strength experienced by the MR fluid 1370 and making the MR fluid 1370 more resistant to flow and stiffer for stronger braking of the plunger 1312 and in turn the spool 1306. Thus, the more the spool 1306 rotates the stiffer the braking force on the spool 1306.

Also in another optional form, the body 1346 may have a bypass or side passage 1508 that may be provide a fluid passage from the right of the restraining portion 1354 back to the left of the restraining portion 1354 in order to release fluid pressure as the restraining portion 1354 moves to the right in the chamber 1348. The fluid pressure may build in the right side of the restraining portion 1354 in the chamber 1348 when the fluid is too viscous to move from the right side of the restraining portion 1354 and through a gap between the sides 1361 of the chamber 1348 and the outer rim 1397 or base magnets 1396, and back to the left side of the restraining portion 1354.

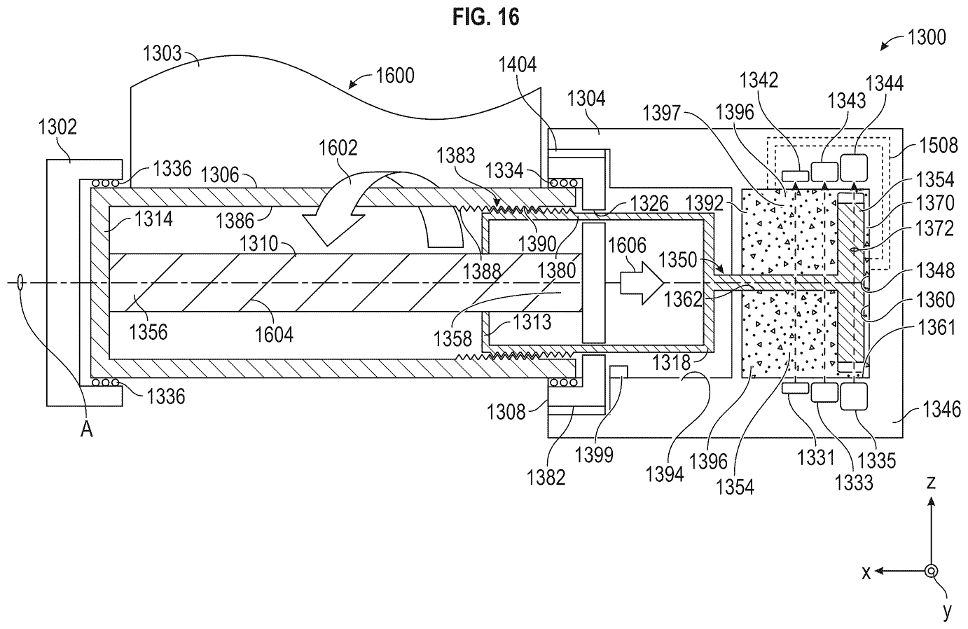

Referring to FIG. 16, a fourth stage 1600 of operation of the retractor 1300 shows that the web 1303 is now moving under severe loads and sufficiently fast to cause the torsion bar 1310 to deform or twist 1604 even more, thereby moving the spool 1306 to continue to rotate as with arrow 1602 about the A-axis. This drives the plunger 1312 to move (as shown by arrow 1606) even more due to the threaded connection 1383 and to the rear or right to a maximum right position at a bottom (or right end) of the chamber 1348. Now the restraining portion 1354 is near the stronger magnets 1344 and 1335, which provide peak magnetic field strength applied to the MR fluid 1370, and in turn peak stiffness of the MR fluid 1370. Thus, by the end of the plunger's 1312 travel, the strength of the magnetic field will peak along with the capability of the damper.

By yet another approach, the dampers disclosed above on the seatbelt retractors also may be used during retraction of the web in addition to controlling payout during web extensions by load limiters. Particularly for one example, the retraction spring, such as a clock spring, wears over time such that the retraction of the web becomes insufficient to adequately force the web against an occupant in the vehicle. Thus, to improve the durability of the retractor spring, the initial or set force of the spring may be increased. The MR Fluid and damper then may be used to counteract the increased force to dampen the reverse rotation speed and/or maintain low forces or loads against the occupant to provide comfort to an occupant's neck for example, and despite the increased spring force.

While the materials that may be used for the rheological fluid and the chamber are mentioned above, the materials of the other components of any of the retractors above of FIGS. 1-16 may be made from metal, plastic, or a combination of both metal and plastic materials. A retractor housing and other plastic components may be constructed from high-strength plastic, such as polypropylene or reinforced nylon. The internal components, such as the spool and locking mechanism, may be made of steel or aluminum. Additionally, the coil (or clock) spring 302 (FIG. 3) used to retract the seatbelt may be made of high-tensile steel. Non-metallic materials such as carbon fiber may be used as well when the strength parameters fit the purpose of the component.

The manufacture of the seatbelt retractor may involve a combination of automated machinery and manual operations, such as with high-speed robotic arms and precision automated systems, press fitting, automated threading, and so forth. Manual placement of parts also may be used.

It will be appreciated that the systems, vehicles, devices, apparatuses, and methods may vary from those depicted in the Figures and described herein. For example, the vehicle 100 of FIGS. 1-16, and any of the components of FIGS. 1-16, may differ from that depicted in FIGS. 1-16.

While at least one example implementation has been presented in the foregoing detailed description, it should be appreciated that a vast number of variations exist. It should also be appreciated that the example implementation or example implementations are only examples, and are not intended to limit the scope, applicability, or configuration of the disclosure in any way. Rather, the foregoing detailed description will provide those skilled in the art with a convenient road map for implementing the example implementations. It should be understood that various changes can be made in the function and arrangement of elements without departing from the scope of the disclosure as set forth in the appended claims and the legal equivalents thereof.

What is claimed is:

1. A seatbelt retractor, comprising:
a housing holding fixed opposing first and second races;
a spool defining an axis of rotation and rotatably mounted on and between the first and second races, wherein the spool is attached to a seatbelt having a web arranged to be wound around the spool and unwound from the spool;
a damper connected to the spool and extending axially relative to the axis;
a body with a chamber holding a rheological fluid, wherein the damper is arranged to axially and movably extend into the rheological fluid to effect motion of the web; and
an activation mechanism that applies energy to the rheological fluid to change a viscosity of the rheological fluid.

2. The seatbelt retractor of claim 1, wherein the rheological fluid is a magnetorheological (MR) fluid, wherein the energy is generated by a magnetic field that causes the rheological fluid to slow or stop rotation of the spool.

3. The seatbelt retractor of claim 1, wherein the rheological fluid is an electrorheological (ER) fluid, wherein the energy is generated by an electric field that causes the rheological fluid to slow or stop rotation of the spool.

4. The seatbelt retractor of claim 1, wherein the damper is rotationally fixed to the spool, and wherein the damper is rotatable within the rheological fluid.

5. The seatbelt retractor of claim 1, comprising a torsion bar and a locking race with a locked state and a rotating state rotatable about the axis, wherein the torsion bar has a first end fixed to the locking race and a second end rotatably fixed to the spool, wherein the torsion bar is arranged to twist when the locking race is in the locked state and the spool is rotating, and wherein a viscosity of the rheological fluid is arranged to be increased in the locked state as a twist of the torsion bar increases.

6. The seatbelt retractor of claim 5, comprising a spindle rotatable about the axis, rotationally fixed to the locking race, axially translatable relative to the locking race, and having a connection to the spool so that rotating the spool in the locked state moves the spindle axially and closer to the chamber, and wherein the spindle has at least one magnet that moves closer to the chamber as the spindle moves closer to the chamber.

7. The seatbelt retractor of claim 6, wherein the spool has a rotatable interior surface, and wherein the spindle is threaded to the interior surface.

8. The seatbelt retractor of claim 1, wherein the spool comprises a distal end facing the chamber, and wherein the damper comprises at least one stem portion extending from the distal end and into the chamber and a restraining portion coupled to the at least one stem portion and being disposed within the rheological fluid.

9. The seatbelt retractor of claim 1, wherein the damper is rotatable about the axis and has a rotationally locked state and a rotationally unlocked state, wherein the damper has a spindle portion within the spool and a restraining portion coupled to the spindle portion and being disposed within the rheological fluid, wherein the spindle portion has a connection to the spool so that the damper moves axially when the spool rotates in the rotational locked state to move the restraining portion axially within the rheological fluid.

10. The seatbelt retractor of claim 1, comprising a damping control communicatively coupled to a field generator and being arranged to selectively control a strength of a magnetic field or an electric field to be applied to the rheological fluid depending on data indicating a current context at the vehicle.

11. The seatbelt retractor of claim 10, wherein the current context comprises at least one of: characteristics of an occupant wearing the seatbelt, an indicator of motion of the web, a force being exerted against the web, a condition or parameter of the vehicle, and navigational-related data indicating objects being detected that are other than part of the vehicle.

12. A seatbelt system, comprising:
a seatbelt having a web extending over at least one seat of a vehicle and having a web end; and
a seatbelt retractor connected to the web end, wherein the seatbelt retractor comprises:
a housing holding fixed opposing first and second races;
a spool defining an axis of rotation and rotatably mounted on and between the first and second races, wherein the spool is attached to a seatbelt having a web arranged to be wound around the spool and unwound from the spool;
a damper connected to the spool and extending axially relative to the axis;
a body with a chamber holding a rheological fluid, wherein the damper is arranged to axially and movably extend into the rheological fluid to effect motion of the web; and
an activation mechanism that applies energy to the rheological fluid to change a viscosity of the rheological fluid while the web is being extended from the seatbelt retractor.

13. The seatbelt system of claim 12, comprising at least one magnet on the damper or in a vicinity of the chamber on the body, and wherein the damper is arranged so that a distance between the at least one magnet and the damper becomes smaller as a velocity or acceleration of the web increases.

14. The seatbelt system of claim 12, comprising at least one movable magnet disposed in a proximity to the chamber and on the body and generating a magnetic field; and at least one magnet actuator on the body and coupled to the at least one movable magnet to move the at least one magnet to a position with a distance from the chamber to apply a predetermined strength of the magnetic field to the rheological fluid.

15. The seatbelt system of claim 12, comprising: a damping control arranged to receive context data to determine a predetermined field strength before a use of the vehicle; and a field generator at the body and communicatively coupled to the damping control to generate a magnetic or electric field at the predetermined field strength to apply to the rheological fluid during the use of the vehicle.

16. A vehicle, comprising:
at least one seat;
a seatbelt at each seat front; and
a seatbelt retractor at each seatbelt, wherein the seatbelt retractor comprising:
opposing first and second races,
a spool defining an axis of rotation and rotatably mounted on and between the first and second races, wherein the spool is attached to a seatbelt web arranged to wind the seatbelt web around the spool,
a damping portion connected to the spool and extending axially relative to the axis,
a body with a chamber holding a rheological fluid, wherein the damping portion extends into the rheological fluid, and
an activation mechanism that applies energy to the rheological fluid to change a viscosity of the rheological fluid.

17. The vehicle of claim 16, wherein the damping portion is rotatable about the axis and has a rotationally locked state and a rotationally unlocked state, wherein the damping portion has a spindle portion within the spool and a restraining portion coupled to the spindle portion and being disposed within the rheological fluid, wherein the spindle portion has a connection to the spool so that the damping portion moves axially when the spool rotates in the rotationally locked state to move the restraining portion axially within the rheological fluid, wherein the body comprises multiple magnets disposed along an axial direction relative to the axis and having different sizes or different materials so that the viscosity of the rheological fluid near the restraining portion is greater the more the spool rotates in the rotationally locked state and the farther the restraining portion axially moves within the rheological fluid from a start position.

18. The vehicle of claim 17, wherein the restraining portion comprises at least one stem portion coupled to the spindle portion and a plate-shaped end coupled to the at least one stem portion, and wherein the plate-shaped end comprises an outer peripheral rim having at least one magnet.

19. The vehicle of claim 16, wherein the first race includes the body and holds the chamber, and wherein the first race comprises a field generator proximal to the chamber and being arranged to form a magnetic or electric field to apply to the rheological fluid in the chamber.

20. The vehicle of claim 16, wherein the activation mechanism is arranged to change the viscosity of the rheological fluid while the web is retracting into the seatbelt retractor.
